(19) United States
(12) Patent Application Publication
(10) Pub. No.: US 2010/0011294 A1
(43) Pub. Date: Jan. 14, 2010

(54) VIDEO MODE INDICATOR TECHNIQUES

(75) Inventor: Yuko Nishikawa, La Jolla, CA (US)

Correspondence Address: SONY C/O MURABITO, HAO & BARNES LLP, TWO NORTH MARKET STREET, THIRD FLOOR, SAN JOSE, CA, 95113, US

(73) Assignees: SONY CORPORATION, Tokyo (JP); SONY ELECTRONICS, INC., Parkridge, NJ (US)

(21) Appl. No.: 12/168,895

(22) Filed: Jul. 8, 2008

(51) Int. Cl. G06F 3/048

(52) U.S. Cl. 715/719

(57) ABSTRACT

The mode indicator techniques include applying a plurality of mode effects to content and generating a graphical user interface including the content formatted in the plurality of mode effects.

### BACKGROUND OF THE INVENTION

Electronic devices have made significant contributions towards the advancement of modern society. An ever increasingly important aspect of electronic devices is the user experience. An important part of the electronic devices that affects the user's experience is the user interface. Electronic devices such as televisions may present content in any one of a plurality of formats, such as standard (e.g., 4:3), fullscreen, widescreen, zoom 14:9, zoom 16:9, super zoom, subtitle zoom or the like. Typically, the user can select a particular format from a setup menu. The setup menu may present a generic still image in each of the available formats. However, the conventional technique sometimes results in the user selecting a mode that the user may not prefer for the particular content that he or she is viewing. Accordingly, there is a continued need for an improved user interface for electronic devices.

### SUMMARY OF THE INVENTION

Embodiments of the present technology are directed toward the configuration of a display mode in electronic devices. In one embodiment a system includes a content source, a video processing unit and a display. The video processing unit applies a plurality of mode effects to content captured from the content source. The video processing unit then generates a graphical user interface including the content formatted in the plurality of mode effects for output on the display.

In another embodiment, a method includes capturing content from a content source. A plurality of mode effects are then applied to the captured content. Thereafter a graphical user interface (GUI) for selecting from a plurality of modes is displayed. The GUI includes the captured content formatted in each of the plurality of mode effects.

### BRIEF DESCRIPTION OF THE DRAWINGS

Embodiments of the present technology are illustrated by way of example and not by way of limitation, in the figures of the accompanying drawings and in which like reference numerals refer to similar elements and in which:

FIG. 1 shows a block diagram of a system for presenting content in one or more mode effects, in accordance with one embodiment of the present technology.

FIG. 2 shows a flow diagram of a method of selecting a given mode effect in accordance with one embodiment of the present technology.

FIG. 3A shows an illustration of an exemplary graphical user interface for selecting a given mode effect, in accordance with one embodiment of the present technology.

FIG. 3B shows an illustration of a graphical user interface for selecting a given mode effect according to the conventional art.

FIG. 4 shows an illustration of an exemplary graphical user interface for selecting a given mode effect, in accordance with another embodiment of the present technology.

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the invention to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

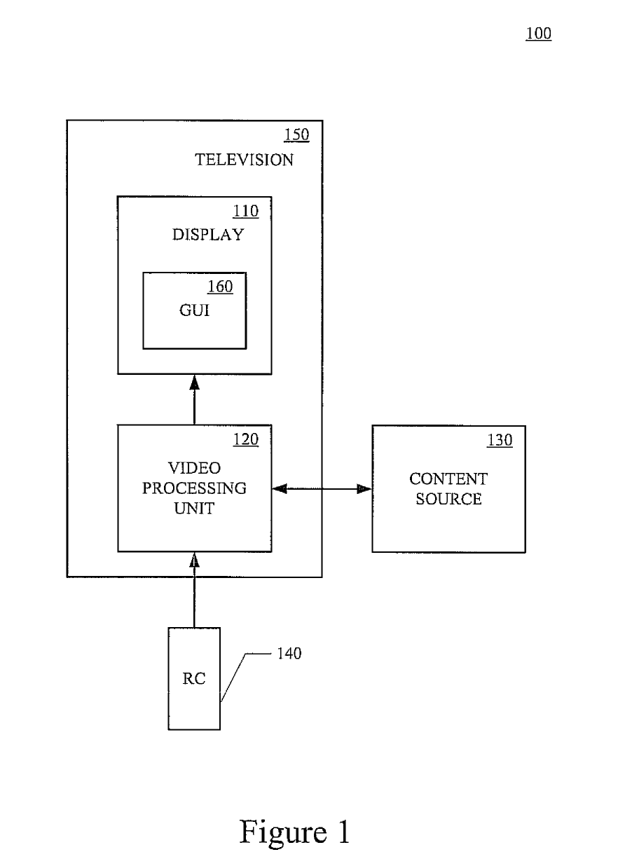

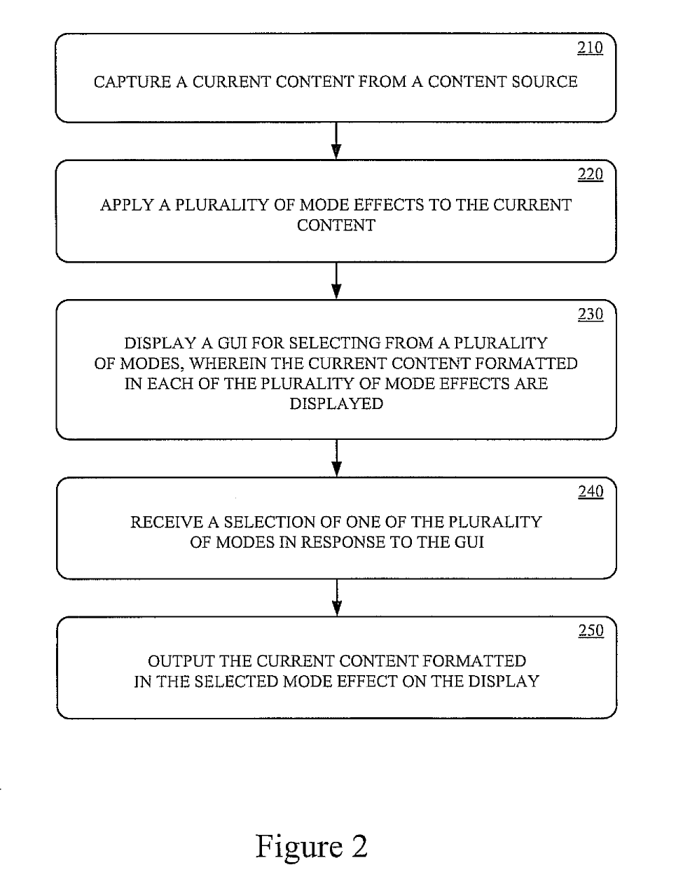

FIG. 1 shows a system for presenting content in one or more mode effects, in accordance with one embodiment of the present technology. Operation of the system will be further described with reference to FIG. 2, which shows a method of selecting a given mode effect in accordance with one embodiment of the present technology. The system 100 includes a display 110, one or more video processing units 120, one or more content sources 130, and one or more input interfaces 140. Each video processing unit 120 may be implemented in hardware, firmware, and/or by software and a microprocessor (e.g., computing device executable commands and data that when executed by a processing unit implement one or more functions including the video mode indicator techniques described herein).

In an exemplary implementation, the display 110 and video processing unit 120 may be part of a television 150, game console, personal computer or the like. The content source 130 may be a set top box (STB), DVD player, hard disk drive (HDD) or the like, and the input interface 140 may be a remote control, keyboard, pointing device and/or the like. However, it is appreciated that the display 110, video processing unit 120, content source 130 and input interface 140 may be arranged in numerous other possible implementations. For example, the video processing unit 120 may be part of one or more content sources 130, or a content source 130 may be part of the television 150, game console, personal computer or the like. The input interfaces 140 may be a remote control, and/or a control panel on the television 150 or one or more of the content sources 130. Furthermore, each input interface 140 may separately control a respective television 150 or content source 130, and/or at least one of the input interfaces 140 may control a plurality of elements that include the television 150 and/or one or more of the content sources 130.

At 210, content is captured from a content source 130 by the video processing unit 120. In one implementation, the content may be captured from a DVD player or set top box (STB). The content may be captured in response to an input from a user that triggers a mode setup process. In another implementation, the content may be captured at the beginning of a given content (e.g., when the user starts a new movie). In one implementation, a video clip (e.g., a plurality of frames) is captured. In another implementation, a single frame is captured. In yet another implementation, a generic animated image may be used to generate the mode effects. At 220, a plurality of mode effects are applied to the captured content by the video processing unit 120. The plurality of mode effects may include standard (e.g., 4:3), fullscreen, widescreen, zoom 14:9, zoom 16:9, super zoom, subtitle zoom and/or the like modes.

At 230, a graphical user interface (GUI) 160 for selecting from the plurality of modes is output on the display 110 by the video processing unit 120. The GUI 160 displays the current content formatted in each of the plurality of mode effects. At 240, a selection of one of the plurality of modes is received in response to the GUI. For example, a user may use an input interface, such as a remote control, mouse or game controller, to highlight and select a given mode from the GUI. At 250, the current content formatted in the selected mode effect is then output on the display 110 by the video processing unit 120 in response to the selection.

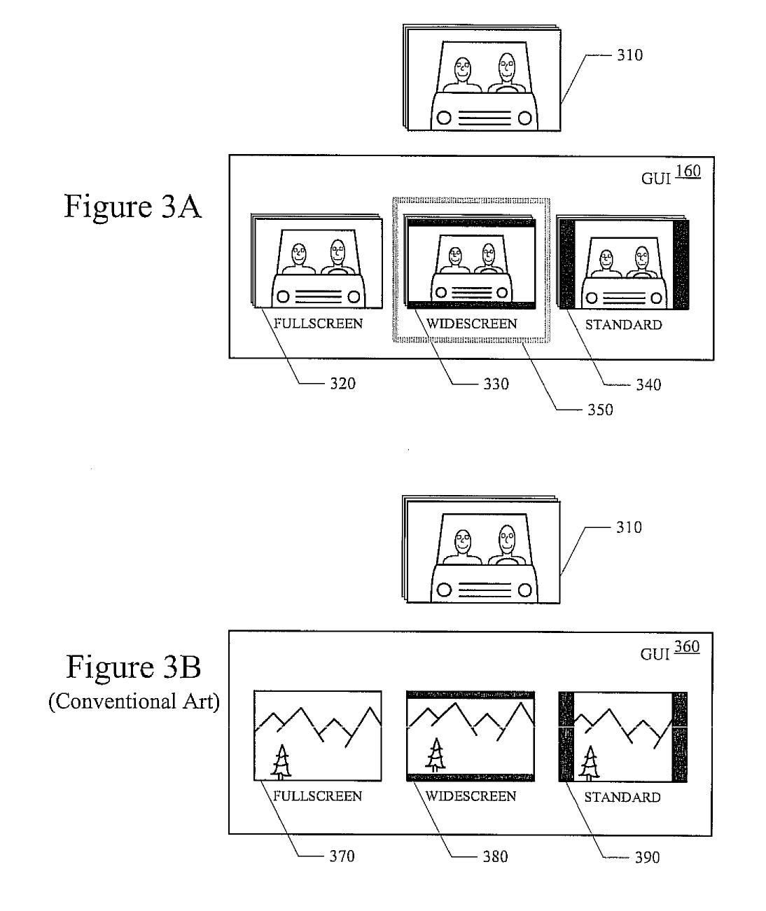

Referring now to FIGS. 3A and 3B, illustrations of an exemplary graphical user interface, in accordance with embodiments of the present technology and the conventional art respectively, are shown. As shown in FIG. 3A, a movie clip to be output on a display 110 may be captured by a video processing unit 120 from a content source 130. A plurality of mode effects, such as fullscreen 320, widscreen 330 and standard 340 may be applied to the content. The plurality of mode effects 320-340 are displayed in a graphical user interface (e.g., setup menu) 160. Although shown as still images in FIG. 3A, the mode effect samples are running video (e.g., animated). A user may use the left or right scroll buttons and the select button on the remote control 140 to highlight and select 350 a particular mode effect.

In contrast, the conventional art, as illustrated in FIG. 3B, does not use the current content 310. Instead, the conventional art displays a static generic picture or graphic (e.g., line drawing) to illustrate the various modes, such as fullscreen 370, widescreen 380 and standard 390, in the graphical user interface 360.

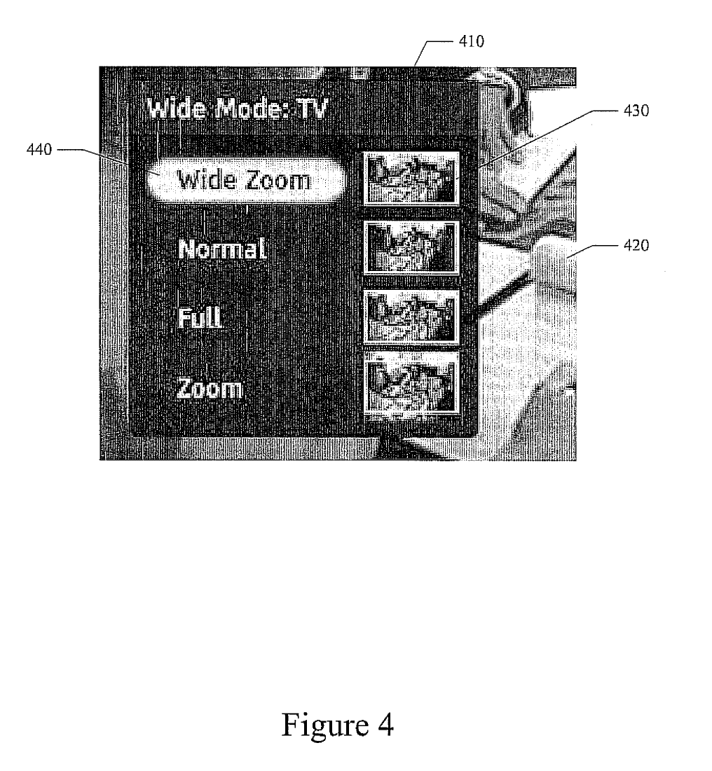

Referring now to FIG. 4, an illustration of an exemplary graphical user interface for selecting a given mode effect, in accordance with another embodiment of the present technology, is shown. The graphical user interface 410 is overlaid on the video 420 content currently being output on the display. A plurality of mode effects 430 shown using the current video content and corresponding mode effect identifies 440 are displayed in the graphical user interface 410. Although shown as still images in FIG. 4, the current video content output on the display and in the mode effect samples in the graphical user interface are running video (e.g., animated). A user may utilize the scroll keys on a remote control to select from the plurality of modes by highlighting a corresponding mode identifier 400 and then activating an enter key on the remote control.

Accordingly, embodiments of the present technology advantageously assist the user with selecting a desired mode effect by presenting improved examples of the mode using the content to be displayed. The user will therefore have a better idea of how the current content will look before actually applying the mode.

The foregoing descriptions of specific embodiments of the present technology have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the Claims appended hereto and their equivalents.

What is claimed is:

1. A system comprising:
a content source;
a video processing unit for applying a plurality of mode effect to content captured from the content source and for generating a graphical user interface including the content formatted in the plurality of mode effects; and
a display for outputting the graphical user interface.

2. The system of claim 1, further comprising an electronic device that includes the video processing unit and the display.

3. The system of claim 2, wherein the electronic device comprise a television.

4. The system of claim 3, wherein the electronic device comprises a computer.

5. The system of claim 3, wherein the content source comprises a digital video disk (DVD) player.

6. The system of claim 3, wherein the content source comprises a set top box (STB).

7. The system of claim 1, further comprising an electronic device that includes the content source and the video processing unit.

8. The system of claim 7, wherein the electronic device comprises a computer.

9. The system of claim 7, wherein the electronic device comprises a game console.

10. The system of claim 1, further comprising:
an input interface for selecting one of the plurality mode effects from the graphical user interface;
the video processing unit for applying the selected mode effect to the content; and
the display for outputting the content in the selected mode effect.

11. A method comprising:
capturing a current content from a content source;
applying a plurality of mode effects to the current content; and
displaying a graphical user interface (GUI) for selecting from a plurality of modes, wherein the current content formatted in each of the plurality of mode effects is displayed.

12. The method according to claim 11, further comprising:
receiving a selection of one of the plurality of modes in response to the graphical user interface; and
outputting the current content formatted in the selected mode effect.

13. The method according to claim 12, wherein the plurality of modes includes a fullscreen mode, a widescreen mode and a standard 4 mode.

14. The method according to claim 11, wherein capturing the current content comprises capturing a plurality of frames of the current content.

15. The method according to claim 11, wherein capturing the current content comprises capturing a single frame of the current content.

16. The method according to claim 11, wherein the current content is captured in response to an input from a user.

17. The method according to claim 11, wherein the current content is captured at the beginning of the current content.

18. One or more computing device readable media for storing computing device executable commands and data which when executed by a processing unit implement a mode indicator method comprising:
applying a plurality of mode effect to content; and
generating a graphical user interface including the content formatted in the plurality of mode effects.

19. The method according to claim 18, wherein the plurality of modes includes a fullscreen mode, a widescreen mode and a standard mode.

20. The method according to claim 18, wherein each of the plurality of mode effects are applied to a plurality of frames of the content.
